(19) United States
(12) Patent Application Publication
(10) Pub. No.: US 2013/0151380 A1
(43) Pub. Date: Jun. 13, 2013

(54) Advanced Order System

(71) Applicant: David Anthony Holt, Whitby (CA)

(72) Inventor: David Anthony Holt, Whitby (CA)

(21) Appl. No.: 13/708,134

(22) Filed: Dec. 7, 2012

(30) Foreign Application Priority Data
Dec. 7, 2011 (CA) 2760307

(51) Int. Cl. G06Q 30/06

(52) U.S. Cl. CPC G06Q 30/0635
USPC 705/26.81

(57) ABSTRACT

In an advanced ordering system, customers enter their orders using a website or application and transfer their order data to a mobile device such as a smartphone, memory chip, GPS, RFID tag or similar capture device. At a merchant, the order data is transmitted from the mobile device to an advanced order terminal and to the merchant's ordering system, thereby reducing the verbal exchanges needed to process the order. In one embodiment, the advanced order terminal may also receive payment information for the order. In this way, a drive through system can reduce the wait times and emissions associated with idling vehicles as customers wait to give or receive drive through orders.

### CROSS REFERENCE TO RELATED APPLICATION(S)

This application claims foreign priority, under 35 USC 119(a), to Canadian Patent Application Serial Number 2,760,307, filed Dec. 7, 2011 the entire disclosure of which is herein incorporated by reference.

### BACKGROUND

1. Field of the Invention

This invention relates to an advanced services ordering systems. In particular, it relates to drive through ordering systems and other similar service systems.

2. Description of the Related Art

Life today has most certainly changed in terms of technology and how busy it seems to have become for everyone. Many of these changes are made evident by the unprecedented economic and population growth around the world. Recently there has been an increase in public awareness of environmental concerns and that have spawned programs around recycling and conservation. Many inventions of our times lay claim to saving a person time but few can also lay claim that they benefit the environment.

Consumerism typically has the opposite affect to the environment and on a person's time. Although it appears that the world is developing at such a fast rate some practices are slow to adopt new technologies. For example, drive through services, though commonplace, are still employing intercom technology that has been around for generations.

In the busy modern world, people consume more time and resources. To save time, we are eating out more and businesses have developed these services as we cope to manage our schedules. This is most evident in the increasing number of restaurants and the reduction in the number of home prepared meals over the years and stores have tried to capitalize on this aspect of convenience as we rationalize purchases to “save time” for ourselves and our families. Drive through services have strived to cater to this need for speed and convenience that customers have become dependent on.

Yet for being so busy, people find themselves spending countless minutes in a drive through or waiting endlessly in line-ups. Idling cars and wasted time are inconsistent with environmental conservation and busy schedules. Drive through restaurants often have line ups extending onto the street and with tens of cars wasting gas and polluting the atmosphere while waiting for service. Although there are countless justifiable reasons to use the drive though including not being able to leave their small children, the people in their care, unable to carry out their large order and medical handicaps, a common perception is that people are simply being lazy.

Often, from a consumer's perspective, when we are in a hurry and are waiting in a line-up for drive through service, we always know exactly what we want to order but the people are slowing down the service while they decide what to have and discuss the options with the restaurant staff.

Often, consumers are not interested in the experience or trying new options but would rather order the same items as ordered previously being creatures of habit.

Drive through services ranging from everything from fast food, prescription drugs and convenience stores appear to have become so ubiquitous that some businesses and consumers could not survive without them. The environmental impact of these drive through services should also be considered. If these services are here to stay, they should be made effective, efficient and environmentally accountable.

Currently, the typical drive through service is less than ideal. Not only a source of obvious pollution by idling in line ups but also through pollution caused by the traffic congestion in the surrounding area, especially in urban centres and potential safety hazards caused by cars lined up on the surrounding roads.

Therefore it is desirable to have an improved ordering service that addresses the environmental concerns of existing drive through services and other related services.

### SUMMARY

Because of these and other problems in the art, described herein is an advanced ordering system and method where customers enter their orders using a website or application and transfer their order data to a mobile device such as a smartphone, memory chip, GPS, RFID tag or similar capture device. At a merchant, the order data is transmitted from the mobile device to an advanced order terminal and to the merchant's ordering system, thereby reducing the verbal exchanges needed to process the order. In one embodiment, the advanced order terminal may also receive payment information for the order. In this way, a drive through system can reduce the wait times and emissions associated with idling vehicles as customers wait to give or receive drive through orders.

There is described herein, among other things, A method for dispensing ordered goods to a plurality of customers comprising: providing a user interface for preparing an order data from a selection of available orders by at least one of the plurality of customers, receiving the order data and communicating the order data to a capture device; receiving the order data from the capture device comprising an order from the at least one of the plurality of customers at an order placement location; processing the order while the at least one of the plurality of customers moves from the order placement location to a second location and at least one other of the plurality of customers is delivered an order; delivering the order to the at least one of the plurality of customers at the second location; and counting the number of orders received at the order placement location and delivered at the second location; whereby each of the at least one of the plurality of customers is provided the fulfilled order corresponding to the completed advanced order template.

In an embodiment, the method further comprises: detecting the arrival of the at least one of the plurality of customers prior to receiving the order data from the capture device, and recording the arrival time of the at least one of the plurality of customers; recording the time of the delivery of the order; calculating the time between the delivery of the order and the arrival to determine the wait time for the at least one of the plurality of customers.

In an embodiment, the method further comprises: receiving payment data, associated with the order data, prior to receiving the order data from the capture device; and processing the order at a second location further comprises, processing the payment data associated with the order.

In an embodiment, the method further comprises: after delivering the order, repeating the step of receiving the order data from the capture device and the subsequent steps.

In an embodiment, the method further comprises: receiving an identification sequence, associated with the order data, prior to receiving the order data from the capture device; and prior to processing the order, receiving the same identification sequence from the at least one of the plurality of customers.

In an embodiment of the method, the capture device is wireless device and receiving the order data from the capture device may comprise a wireless communication from the capture device to a base station associated with the order placement location.

In an embodiment, the method further comprises: prior to delivering the order, identifying the at least one of the plurality of customers and associating the at least one of the plurality of customers with an order.

There is also described herein, a system for dispensing ordered goods to a plurality of customers, the customers having capture devices comprising orders, the system comprising: an advanced order terminal for receiving the order data from the capture device from at least one customer, the order data comprising an order; an order terminal for receiving orders from at least one customer; and an order processing facility for fulfilling orders and providing fulfilled orders to the at least one customer, the order processing facility in communication with the advanced order terminal for receiving order data from the advanced order terminal; whereby customers receive the orders corresponding to the completed advanced order template and an estimate for the duration for each customer can be determined from the start time, the end time and the number of customers using the system.

In an embodiment of the system the advanced order terminal has a wireless base station for receiving the order data from the capture device.

In an embodiment, the system further comprises: a customer arrival detector for detecting the arrival of at least one customer and recording the time of the at least one customer; an order delivery time recorder for recording the time of providing fulfilled orders to the at least one customer at the order processing facility; and a processor for calculating the wait time for at least one customer using the arrival time and the delivery time of the at least one customer.

In an embodiment, the system further comprises a payment processor in communication with the advanced order terminal for receiving payment data from the advanced order terminal and processing the payment data.

In an embodiment of the system, the advanced order terminal further comprising a receiver for receiving payment information from the capture device.

### BRIEF DESCRIPTION OF THE FIGURES

The following drawings illustrate by way of example and not by limitation,

FIG. 1 shows a flow chart with steps in an embodiment of the invention.

FIG. 2 shows a block diagram of an embodiment of the invention.

FIG. 3 is a top view of an embodiment of the invention in location at a drive through restaurant.

### DESCRIPTION OF PREFERRED EMBODIMENT(S)

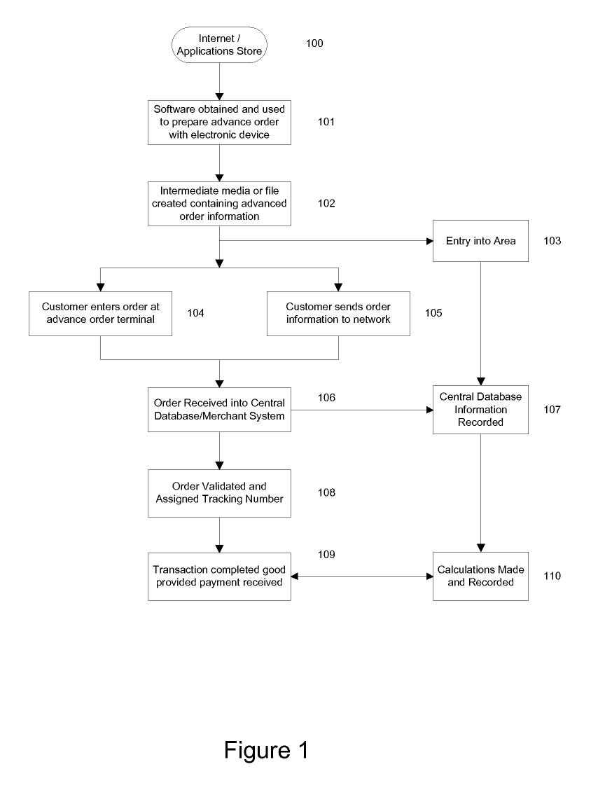

In relation to FIG. 1, in an embodiment, a customer accesses the internet to obtain software from a website or other online service 200 for preparing their advanced order for a particular merchant, as indicated at 100. The merchant may be any retail operation that provides real time or fast service such as a fast food restaurant. The advanced orders are based on the options available at the merchant, such as listed on their menu.

The customer uses the software obtained in 100 on an electronic device 205 to prepare their advance order as indicated at 101. The electronic device may be a personal computer or a mobile communications device such as a smartphone, cell phone, GPS or tablet. When the customer indicates using the software on the device 205 that the order being created is complete, the software may generate order data 206, preferably using a file format or file type, such as XML or text, that is appropriate for the type of capture device they wish to employ. The software or the server provides the order data, such as in a file format or file type, which identifies an order for the merchant. The data is loaded or stored on a capture device 210 that can be carried with the customer, either contained within a mobile communications device, such as a cellphone or smartphone or separately, such as a barcode, 2D barcode, RFID tag, memory stick, USB key, near field compatible device, short range wireless device or similar device. The order data may be loaded using an appropriate interface 206, such as a cable, wireless interface, barcode printer, RFID writer or similar interface appropriate for the capture device 210. In one embodiment, the order data 206 loaded on the capture device 210 contains the advanced order information. In one embodiment, the capture device only contains the order data and no personal identification information. In this way, if the capture device is lost or stolen, information about the customer is not compromised. In an embodiment, the user may provide payment information to facilitate payment of the advance order at the time of ordering.

An identification sequence, such as a number, alphanumeric sequence or other identifier, such as a personal identification number (PIN) may be provided with the advance order. Using the PIN, the data stored or loaded on the capture device 210 may be secured so that the data may only be used in conjunction with the PIN. In an embodiment, the advanced order terminal, described below may prompt the customer to enter the same PIN when receiving the advanced order.

In an embodiment, the system may request or require the customer to agree to payment terms for any orders obtained using the advanced order system. For example, the advanced order may be associated with a loyalty program or a credit card so that at the time of placing an advanced order, the customer is charged for the order without requiring further authorization.

When a customer arrives at the merchant in their vehicle 305, the arrival time of the customer is preferably determined by the system. The arrival time may be determined by detecting by a vehicle detection device 300 when the customer's vehicle enters the driveway or drive through 302. The detection device 300 may use a compressed air tube running across the driveway, a visible or infrared beam that is interrupted by passing vehicles, cameras, or similar systems. The arrival time may also be detected using wireless technology, such as RFID tags previously placed on customer vehicles, or detecting the location of customer wireless mobile devices such as customer cellphones or GPS device. The arrival time may also be determined by the customer pushing a button or other indicator when they arrive at the premises approach one of the terminals, or while at a terminal, referred to below.

The arrival time of customers is recorded, preferably in a central data store 223 associated with the merchant. The arrival time is recorded in association with an identifier, such as a customer number, phone number or license plate number to associate the arrival time with a customer or vehicle. The data store may be a database. The arrival time information is used, as will be discussed below, to determine the time a customer waits or spends at the merchant for service. In some embodiments, the arrival time may be estimated or approximated based on the information available to the system.

In an embodiment, the merchant provides an advance order terminal 301 or electronic network 304 that accepts the order information from the customer as indicated at 104 and 105. One or more advanced order terminal 310 are placed proximate to the drive way or drive through 302 at the merchant so that customers using the drive through service utilize the terminal. In an embodiment, the terminal 310 identifies the customer's advanced order by detecting the order data 206 stored or loaded on the capture device 210, such as the RFID, reading the barcode or the customer's mobile communications device.

The advanced order terminal 310 preferably detects order data 206 from the customer using the capture device 210 such as RFID tag, barcode, chip card, memory card, wireless device or other means to which the advanced order data 206 was previously communicated. In one embodiment, the customer may modify or select their order by using a touch screen, keypad or verbal instructions with an automated system or by verbal communication with the merchant's staff while the customer is at the advanced order terminal 310.

The capture device 210 may be re-used by a customer. For example, a customer may order the same items every day on the way to work and so may use the same capture device each day to obtain the same order. In one embodiment, the same capture device may hold more than one advanced order for a merchant which is selected at the time of placing the advanced order at the advanced order terminal. In one embodiment, the capture device may hold more than one advanced order for more than one merchant. The advanced order terminal for a particular merchant may obtain and display the selection and confirmation the advanced order or orders applicable for that merchant.

The advanced order terminal 310 transmits the detected information to a processing unit.

The order is received and verified by one or more of the merchant's computer system, the advanced order terminal 310, the merchant's point-of-sale (POS) terminals network 222 and the central data store 223 associated with the merchant. Once received and verified, an identification number is assigned to the order as indicated at 108. The same or different identification number is provided to the customer using an output device 312 electronically, such as being displayed on the advanced order terminal or transmitted to the capture device 210, the customer's mobile communications device or by another output method, such as a paper receipt, to the customer for order tracking and confirmation.

For customers not using the advanced ordering system, a conventional drive through order terminal 303 using bi-directional voice communication with the merchant's staff allow a customer to provide their order details verbally and for the merchant to clarify any of the order details. The merchant can then enter the order into their order processing system manually. In one embodiment, the customer using the advanced order system may provide their advanced order number or other identification information to the merchant at the conventional order terminal 303. In this way, the order processing system can place the advanced order in the order queue.

The order is then processed and filled by the merchant as would be known to a person skilled in the art as indicated at 109. The customer drives their vehicle 305 through the drive through line up to the pickup window 320 to obtain the results of their order. In one embodiment, the customer pays for the order at the time of picking up the order. Payment may alternatively be made at a separate payment window. Further alternatively, the customer may pay for their order at the advanced order terminal 310 using any known payment means. The payment details may be provided within the advanced order data 206 and processed electronically. The payment may be subject to verification of an advanced order payment agreement. For example, the advanced order data 206 may include a loyalty card number, credit card number or debit card number that is processed automatically or the advanced order terminal may require the customer to enter a PIN or other authorization indication to confirm the payment.

To process the payment, the merchant point of sale terminal 222 may communicate with a data store 223, the merchant loyalty card data store 230 and a payment system provided by a third party, such as a credit card processor 232.

The time when the order is completed is recorded and the recorded time transferred to the data store 223. In one embodiment, the merchant staff indicates when an order is complete so the order processing system advances to the next order in the queue. In one embodiment, the order processing system displays a number of pending orders, such as four pending orders, and displays the next order when the first order in the queue is completed. The orders are maintained in queue by the order processing system to correspond with the order of the vehicles in the drive through line up.

In one embodiment, the order processing system maintains two queues. The first queue being orders for customers in vehicles approaching the pickup window that need to be fulfilled imminently. The second queue of advanced orders that have been received by the system, either at the advanced order terminal or wirelessly but which have not yet been added to the first queue. In one embodiment, orders in the second queue may be transferred to the first queue upon receiving an indication from the customer at the conventional order terminal, such as by providing an order number or indicating that an advanced order has already been place.

The time between the customer's arrival at the merchant and completion of the order is used to generate an estimate of the emissions made by the customer's vehicle 305 during that period. In one embodiment, the system correlates the arrival and departure times of a customer using a first-in-first-out queue since each vehicle 305 that arrives at the drive though passes through the line up to the pickup window. In another embodiment, the customer is tracked using a tracking identifier such as an RFID tag or license plate number. The estimate for the time between the customer's arrival and completion may be based on models for standard car emissions and experimental data for car emissions.

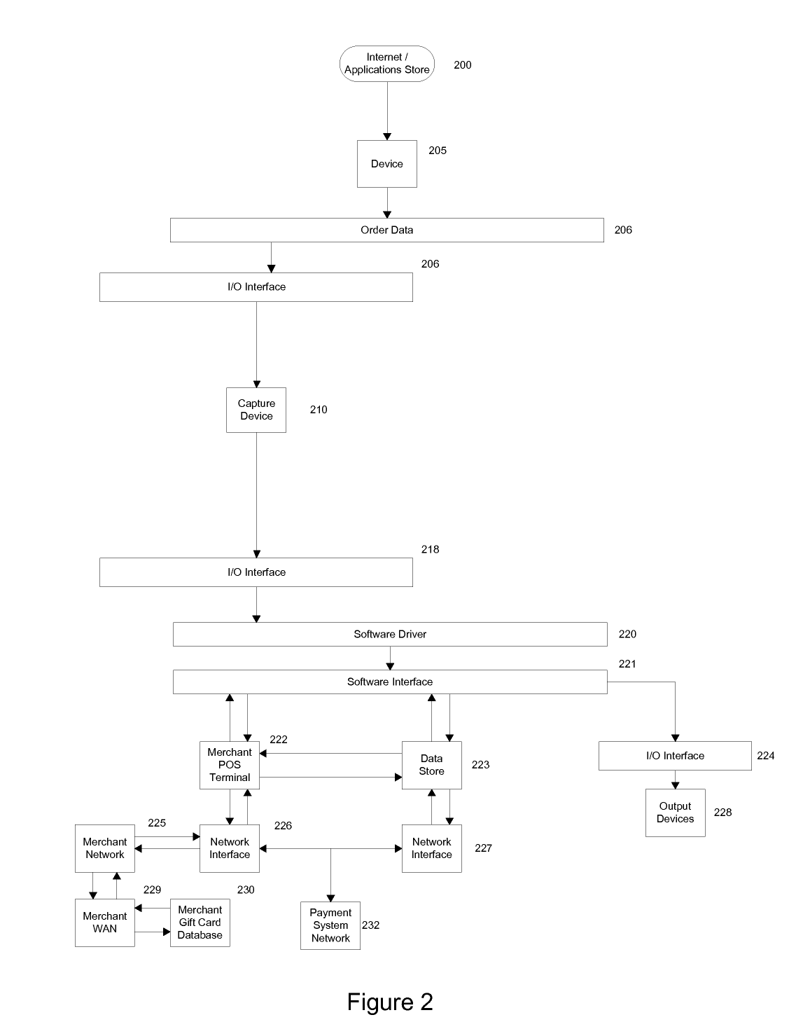

In FIG. 2, various embodiments are shown. Using a website or application store 200, a merchant provides the software to preparing advance orders to customers using one or more electronic devices 205. A website may be provided using a web server provided by the merchant or a third party as is known to a person skilled in the art that is accessible using web browser, such as that available on PCs, smartphones, tablets and other devices. An application store may be provided by a vendor, such as the Apple or Google to be a market place for software compatible with certain mobile devices.

When executed or displayed on a computer or mobile device, the software, website or application will provide a graphical user interface that displays all of the items that the merchant allows for advance order and any special notes or considerations of the order. For example, the graphical interface may display options for “hamburger”, “veggie burger”, “bison burger” with notes for the available condiments. The interface may also provide options for the type of capture device 210, such as mobile phone, smartcard, RFID tag, USB key, bar code or memory stick that the customer wishes to use.

The interface may also provide options for the customer to include identification information so the customer can be accurately identified and to ensure the pre-ordering system is not used by an unauthorized customer. The interface may also provide functionality to associate the customer with a payment mechanism, such as a loyalty cards, credit card or chequing account. In one embodiment, a PIN number or other authorization may be received at the time of the payment transaction, either at the advanced order terminal. In this way the orders made using the advanced order system can be paid automatically rather than requiring payment at the time of pickup.

An electronic device 205, such as a computer, smartphone or other similar device, may be used to access the website or to use an application provided through an application store to display the interface discussed above.

After receiving the selections and notes from the customer using the application or website, the system provides order data 206 for communication to a capture device 210, such as a mobile device, RFID tag, memory stick, bar code or similar mobile. The order data may be formatted in a file format or file type suitable for transmission or transfer to the capture device through an interface 206. In an embodiment, the electronic device 205 and the capture device 210 may be the same device, for example a smart phone. For example, the order data 206 may be communicated using a suitable interface 206 such as to an RFID reader/writer for the creation of an RFID tag, outputted to a memory card or chip card with a memory card reader/writer, outputted through a barcode generator to create a barcode such as a 2D, QR (Quick Response), or other bar codes known to a person skilled in the art via a printer or on a computer or screen as found on a smart phone. The barcode should be readable by the advanced order terminal to identify the advanced order.

Additionally or alternatively, the order data 205 can be made available through a network or communications for transfer by wireless protocols known to a person skilled in the art, such as Wi-Fi or to Bluetooth capable devices 215 using a wireless Bluetooth network 217. Additionally the intermediate media, applications or services can be provided by third parties or the consumer.

In continuation of the embodiments of this invention, once the advance order data 206 is transferred to a capture device 210 described above, the customer presents the order data 206 to an input device at the merchant from the capture device 210 using a suitable interface 218. For an RFID tag the input device may be a RFID reader; for a barcode containing the advance order information the input device will be barcode readers; for a chip card or memory card, the input device will be an appropriate card reader; for a data file, the input device may be a wireless network, Bluetooth network or a network access point. The input device may be integrated with the advanced order terminal 310 described above.

Once received from the customer's capture device 210, the information regarding the advanced order, the order data 206 may be transferred through the interface for the input device 218 and any software drivers 220 as would be known to a person skilled in the art to supply the order information to the merchant's order processing system, merchant's sales network 225 and/or point-of-sale (POS) terminal 222. The order information may be provided to and stored at a data store associated with the merchant using a database 223. In an embodiment, the order data is transferred to the data store and then transmitted to the merchant systems.

The order is confirmed by the merchant's order systems and when verified an order identification number may be assigned. The verified order information, including an identification number may be sent to a variety of output devices 228 such as a graphical user interface integrated with the advanced order terminal, a ticket dispensing machine for either the merchant's purpose within the merchant's premises or for confirmation and viewing by the customer after placing the order.

In an embodiment, the confirmation and order identification number is transmitted wirelessly to the customer's mobile communication device, such as by using the Wi-Fi or Bluetooth network used for the order placement. The order identification number or another system generated number can be used by the customer for order confirmation.

The information about the advance order, the order data 206 is processed by the merchant or at the data store. The data store 223 may be dedicated to processing advanced orders or may be integrated with the data store for other merchant systems. Graphical user interfaces (GUI) of the merchant order processing system display the advanced orders in the system. The GUI may provide functionality so that the sequence of the advanced orders in the may be arranged in a queue based on the sequence of the customers in the line up. In an embodiment, the customer may indicate their order number or other identify verbally at a bi-directional intercom so that merchant staff can place the advanced orders in a processing queue.

In an embodiment, the order data 206 may include payment information. In this way the customer's payment means can be provided to the merchant's system automatically at the time of order or at a later time when the customer is ready to leave. This information can be used to automatically or manually interface existing payment system(s) network such as Interact™, credit card services or alternatively the merchant network of gift cards. The payment means may be secured using encryption or other security means known to a person skilled in the art to reduce the risk of unauthorized payments or use of the order data.

After the customer has received their order and the transaction is complete, the time for completing the transaction is recorded and stored at a data store 223. Using the time for both the arrival and completion of the transaction, estimates of the through rate, idle time and efficiency of the drive through business can be generated. Such estimates may include the total number of vehicles processed by the merchant in a given amount of time, the length of time vehicles were idling while waiting to place their order and obtain their order, an estimate of the resulting CO₂ emissions from the idling cars, proportion of the vehicles and customers that used the advanced ordering system, efficiency measurements of the drive through service, order processing time, service time or other business metrics of efficiency.

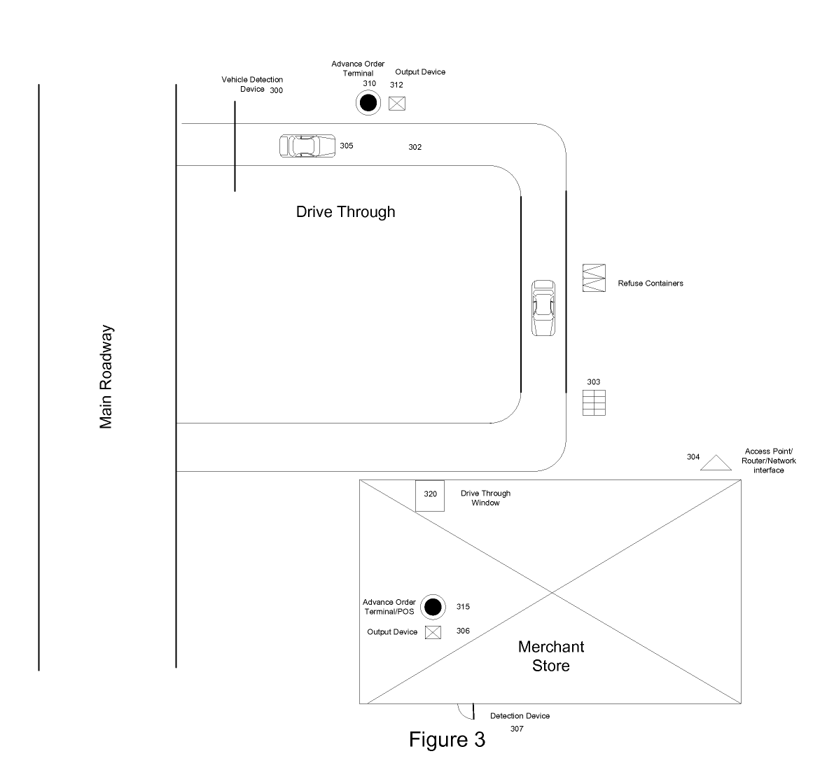

In relation to FIG. 3, depicts a simplified arrangement of a merchant with an advanced order system as described and included by the embodiments of this invention where the customer is already in possession of an order suitable for advance ordering.

Upon entry onto the merchant property a means of detection exists for record of the customer entry 300, 307.

Advanced order terminals 310, 315 are positioned so that the customer may communicate their orders to the terminal using one of the means discussed above. In embodiments utilizing a wireless means of transmission, an access point interface 304 may be positioned in a suitable location to provide wireless coverage over the premises.

Once the order is validated and received by the system it can be outputted to a variety of output devices including a display screen on the advanced order terminal 310, 315 or a ticket dispenser 312, 306 located near the advanced order terminal where the advance order was received.

In one embodiment, customers who walk into the merchant's premises can use an advanced order terminal within the building to transmit their orders to the merchant's ordering system. In this way, customers do not need to confer with the merchant's staff to place their orders, allowing staff to focus on delivering services, reducing the staffing requirements and the time needed to process the orders. In an embodiment, additional goods or services may be ordered and the payment data or payment service agreement associated with the capture device used to authorize, validate or provide payment of the goods or services ordered. In this way, a customer can place their order and pay for the order without requiring the involvement of the staff.

For customers who want to modify their advanced orders after the advanced order data is received by the advanced order terminal 310, the advanced order terminal 310 may be provided with a touch screen, keypad, bi-directional intercom or other means for providing modifications to the order. In an embodiment, customers may modify their advanced order using the conventional order terminal 303. For customers not using the advanced order system, a conveniently ordering system may be provided using a display and intercom terminal at a conventional order terminal 303.

Once the transaction is completed the start and finish times of the transaction are used for the calculations on business and/or environmental efficiencies. While the invention has been disclosed in connection with certain preferred embodiments, this should not be taken as a limitation to all of the provided details. Modifications and variations of the described embodiments may be made without departing from the spirit and scope of the invention, and other embodiments should be understood to be encompassed in the present disclosure as would be understood by those of ordinary skill in the art.

1. A method for dispensing ordered goods to a plurality of customers comprising:
providing a user interface for preparing an order data from a selection of available orders by at least one of the plurality of customers, receiving the order data and communicating the order data to a capture device;
receiving the order data from the capture device comprising an order from the at least one of the plurality of customers at an order placement location;
processing the order while the at least one of the plurality of customers moves from the order placement location to a second location and at least one other of the plurality of customers is delivered an order;
delivering the order to the at least one of the plurality of customers at the second location; and
counting the number of orders received at the order placement location and delivered at the second location;
whereby each of the at least one of the plurality of customers is provided the fulfilled order corresponding to the completed advanced order template.

2. The method of claim 1 further comprising:
detecting the arrival of the at least one of the plurality of customers prior to receiving the order data from the capture device, and recording the arrival time of the at least one of the plurality of customers;
recording the time of the delivery of the order;
calculating the time between the delivery of the order and the arrival to determine the wait time for the at least one of the plurality of customers.

3. The method of claim 1 further comprising:
receiving payment data, associated with the order data, prior to receiving the order data from the capture device; and
processing the order at a second location further comprises, processing the payment data associated with the order.

4. The method of claim 1 further comprising after delivering the order, repeating the step of receiving the order data from the capture device and the subsequent steps.

5. The method of claim 1 further comprising
receiving a identification sequence, associated with the order data, prior to receiving the order data from the capture device; and
prior to processing the order, receiving the same identification sequence from the at least one of the plurality of customers.

6. The method of claim 1 wherein the capture device is wireless device.

7. The method of claim 6 wherein receiving the order data from the capture device comprises a wireless communication from the capture device to a base station associated with the order placement location.

8. The method of claim 1 further comprising, prior to delivering the order, identifying the at least one of the plurality of customers and associating the at least one of the plurality of customers with an order.

9. A system for dispensing ordered goods to a plurality of customers, the customers having capture devices comprising orders, the system comprising:
an advanced order terminal for receiving the order data from the capture device from at least one customer, the order data comprising an order;
an order terminal for receiving orders from at least one customer; and
an order processing facility for fulfilling orders and providing fulfilled orders to the at least one customer, the order processing facility in communication with the advanced order terminal for receiving order data from the advanced order terminal;
whereby customers receive the orders corresponding to the completed advanced order template and an estimate for the duration for each customer can be determined from the start time, the end time and the number of customers using the system.

10. The system of claim 9, wherein the advanced order terminal having a wireless base station for receiving the order data from the capture device.

11. The system of claim 9, further comprising:
a customer arrival detector for detecting the arrival of at least one customer and recording the time of the at least one customer;
an order delivery time recorder for recording the time of providing fulfilled orders to the at least one customer at the order processing facility; and
a processor for calculating the wait time for at least one customer using the arrival time and the delivery time of the at least one customer.

12. The system of claim 9, further comprising a payment processor in communication with the advanced order terminal for receiving payment data from the advanced order terminal and processing the payment data.

13. The system of claim 12, wherein the advanced order terminal further comprising a receiver for receiving payment information from the capture device.
